(19) United States
(12) Patent Application Publication
(10) Pub. No.: US 2007/0294340 A1
(43) Pub. Date: Dec. 20, 2007

(54) Method and system for providing a payment incentive for distributing digital files over a network

(75) Inventor: Leigh M. Rothschild, Sunny Isles Beach, FL (US)

Correspondence Address: CASELLA & HESPOS, 274 MADISON AVENUE, NEW YORK, NY, 10016, US

(73) Assignee: Rothschild Trust Holdings, LLC, Sunny Isles Beach, FL (US)

(21) Appl. No.: 11/810,035

(22) Filed: Jun. 4, 2007

Related U.S. Application Data
(63) Continuation-in-part of application No. 11/373,322, filed on Mar. 10, 2006.

(51) Int. Cl. G06F 15/16

(52) U.S. Cl. 709/203

(57) ABSTRACT

A method and system for providing a payment incentive for downloading and promoting digital content files over a network, e.g., the Internet, are provided. The present disclosure provides for providing a web site for promoting content hosted by at least one server in communication with the network; receiving an indication of at least one digital content file by the web site from a first user; charging the first user a predetermined amount to promote the at least one digital content file; presenting the at least one digital file for promotion on a portion of the web site associated with the first user, wherein subsequent at least one second users pay the predetermined amount for promoting the at least one digital content; and distributing to the first user a first distribution percentage of a total of the predetermined amounts collected.

### PRIORITY

This application is a continuation-in-part application of U.S. application Ser. No. 11/373,322 filed on Mar. 10, 2006, the contents of which are incorporated by reference in its entirety.

### BACKGROUND

1. Field

The present disclosure relates generally to digital content distribution systems, and more particularly, to a method and system for providing a payment incentive for distributing digital files over a network.

2. Description of the Related Art

Many millions of digital files are now stored on the Global Computer Network (GCN) know as the Internet. These files take on many forms including but not limited to text files (in many file formats including Microsoft Word, Adobe PDF, and other formats), video files (including Mpeg-2-3-4, wmv, quicktime, real video, dmrv, and other formats), picture files (including jpg, bmp, tiff, and other formats), audio files (including aac, wma, mp3, and other formats) and other file types.

Commonly, these files are posted on the GCN for others to utilize. The process of posting the file can be referred to as uploading the file. The process of accessing the file can be referred to as downloading the file.

Increasingly digital file downloads are purchased in e-commerce transactions. Examples of companies that sell digital files online are numerous and include Apple Computer, Inc. of Cupertino, Calif. who sells music files in its iTunes branded audio store. Typically, the user pays for these files in an e-commerce transaction and then downloads them from the iTunes remote server. Additionally, Audible.com of Wayne, N.J. also sells audio files, e.g., audio books, audio magazines, etc., to ‘listeners’ who pay for the files and then download them to a personal computer or other media playback device. Other examples include CNN Pipeline of Atlanta, Ga. who sells streaming video files that the user downloads (or streams) to his/her computer and Amazon.com of Seattle, Wash. who sells text files, e.g., e-books.

Increasingly, creators of digital content are utilizing the GCN as a means for selling their digital content and a source of revenue. The challenge for a creator and/or publisher of digital content is to cause that content to be widely purchased by GCN users, which will correspondingly give the creator/publisher increased revenue and income. However, the challenge of achieving wide distribution of digital content does not have an easy solution. The digital content creator/publisher has substantial competition in the marketplace and increasing costs in order to make users to be aware of their content.

Numerous sites now exist on the Global Computer Network (e.g., the Internet) that focus on bringing people together and allowing them to share information and content. Examples of these sites include My Space, You Tube, Friendster, Facebook, Reever, among others. Millions and millions of units of digital content in the form of videos, music content, and other digital content are now being hosted on various websites on the global computer network. With so much digital content to choose from, a need exists to promote specific content to specific users.

### SUMMARY

A method and system for providing a payment incentive for distributing digital files over a network are provided. The method and system allow a publisher, distributor(s), and/or users to receive a payment incentive for downloading digital files on the Global Computer Network, e.g., the Internet. The present disclosure creates a method and system that will be viral in terms of the desire to distribute and utilize these files and to receive payment for the utilization of the files.

Furthermore, the present disclosure describes a system and method for any user to promote any content that he/she locates on the global computer network, e.g., the Internet. This promotion is not limited to content that has been originated/published by the user but is open to any content files found on a network, e.g., the Internet. The system and method of the present disclosure provides a payment incentive for users to access and promote digital content files on the Internet. Additionally, the system and method allows users to easily identify digital content of interest and then list or post that content on an alternative Internet web site, e.g., a promotion web site, for subsequent users to view or promote.

According to one aspect of the present disclosure, a method for distributing digital content files over a network is provided including providing a web site for promoting content hosted by at least one server in communication with the network; receiving an indication of at least one digital content file by the web site from a first user; charging the first user a predetermined payment amount to promote the at least one digital content file; presenting the at least one digital file for promotion on a portion of the web site associated with the first user, wherein subsequent at least one second users pay the predetermined amount for promoting the at least one digital content; and distributing to the first user a first distribution percentage of a total of the predetermined amounts collected. The at least one digital file may be an audio file, a video file, a multimedia file, a text file or a software application.

In a further aspect, the method further includes distributing a second distribution percentage of the total collected to a file agent of the at least one server hosting the web site.

In another aspect, the method includes determining a first threshold of subsequent at least second users; and distributing the first distribution percentage of the total collected to a number of subsequent at least second users equal to the first threshold.

In a further aspect, the method further includes notifying the at least one second user of the presented at least one digital file, wherein the notifying the at least one second user is performed by e-mailing or instant messaging.

In still a further aspect, the charging the first user further includes prestoring account information of the first user; and automatically deducting the predetermined payment amount from the account information of the first user upon selection of the at least one digital content file by the first user.

In another aspect, the method further includes receiving an indication of an identity of the first user; and deducting the predetermined amount from an account associated with the first user.

In a further aspect, the method further includes presenting on the web site a promotion success rate for the first user, wherein the promotion success rate equals a total amount distributed to the first user divided by a total charged to the first user for promotion the at least one digital file.

According to another aspect, a server for distributing digital content files over a network includes a processor configured for providing a web site for promoting content; a communication device configured for coupling the server to the network and receiving an indication of at least one digital content file by the web site from a first user; and the processor further configured for charging the first user a predetermined payment amount to promote the at least one digital content file, presenting the at least one digital file for promotion on a portion of the web site associated with the first user, wherein subsequent at least one second users pay the predetermined amount for promoting the at least one digital content; and distributing to the first user a first distribution percentage of a total of the predetermined amounts collected.

According to a further aspect, a program storage device readable by a machine, tangibly embodying a program of instructions executable by the machine to perform method steps for distributing digital content files over a network is provided, the method steps including providing a web site for promoting content hosted by at least one server in communication with the network; receiving an indication of at least one digital content file by the web site from a first user; charging the first user a predetermined payment amount to promote the at least one digital content file; presenting the at least one digital file for promotion on a portion of the web site associated with the first user, wherein subsequent at least one second users pay the predetermined amount for promoting the at least one digital content; and distributing to the first user a first distribution percentage of a total of the predetermined amounts collected.

In a further aspect, a method for distributing digital content files over a network is provided, the method including the steps providing at least one first client application in communication with the network; selecting at least one digital content file on the network with the at least one client application for promotion; presenting the at least one digital content file for promotion on a portion of a web site for promoting content residing on at least one server, the portion of the web site being associated with the at least one first client application, wherein subsequent at least one second client application pays a predetermined amount for promoting the at least one digital content; and receiving by the at least one first client application a first distribution percentage of a total of the predetermined payments amounts collected. The method further includes charging the at least one first client application a predetermined payment amount to promote the at least one digital content file.

In another aspect, the method further includes analyzing the at least one digital content file to determine a location of the at least one digital content file on the network, wherein the presenting the at least one digital file includes posting a link on the portion of the web site associated to the first user indicative of the location of the at least one digital content file or embedding the at least one digital content file on the portion of the web site associated to the at least one first client application.

In yet another aspect of the present disclosure, an apparatus for distributing digital content files over a network is provided including at least one first client application in communication with the network; means for selecting at least one digital content file on the network with the at least one client application for promotion; means for presenting the at least one digital content file for promotion on a portion of a web site for promoting content residing on at least one server, the portion of the web site being associated with the at least one first client application, wherein subsequent at least one second client application pays a predetermined amount for promoting the at least one digital content; and means for receiving by the at least one first client application a first distribution percentage of a total of the predetermined payments amounts collected.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a flow diagram of a method and system for providing a payment incentive for distributing digital files over a network in accordance with an embodiment of the present disclosure;

FIG. 2 is an exemplary server for use in the system shown in FIG. 1;

FIG. 3 is a flow diagram illustrating a method for providing a payment incentive for distributing digital files over a network in accordance with an embodiment of the present disclosure;

FIG. 4 is a flow diagram illustrating a method for determining a distribution amount to be paid to an end user; and

FIG. 5 is a flow diagram illustrating a method for providing payment incentive for users to promote digital content files over a network in accordance with an embodiment of the present disclosure.

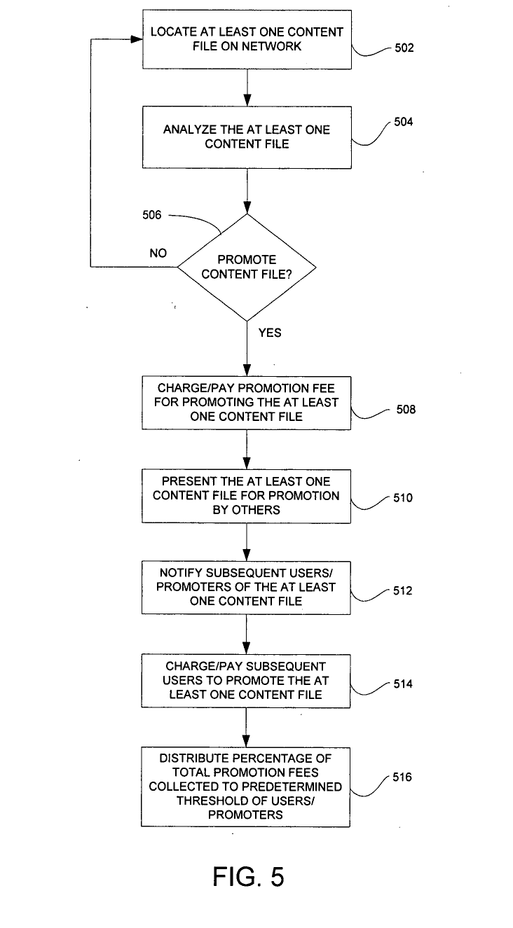

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A method and system for providing a payment incentive for distributing digital files over a network are provided. The method and system allow a publisher, distributor(s), and/or users to receive a payment incentive for downloading digital files on the Global Computer Network, e.g., the Internet. The present disclosure creates a method and system where every party along the distribution chain will have an incentive (even an end user) for further distribution of the digital content file.

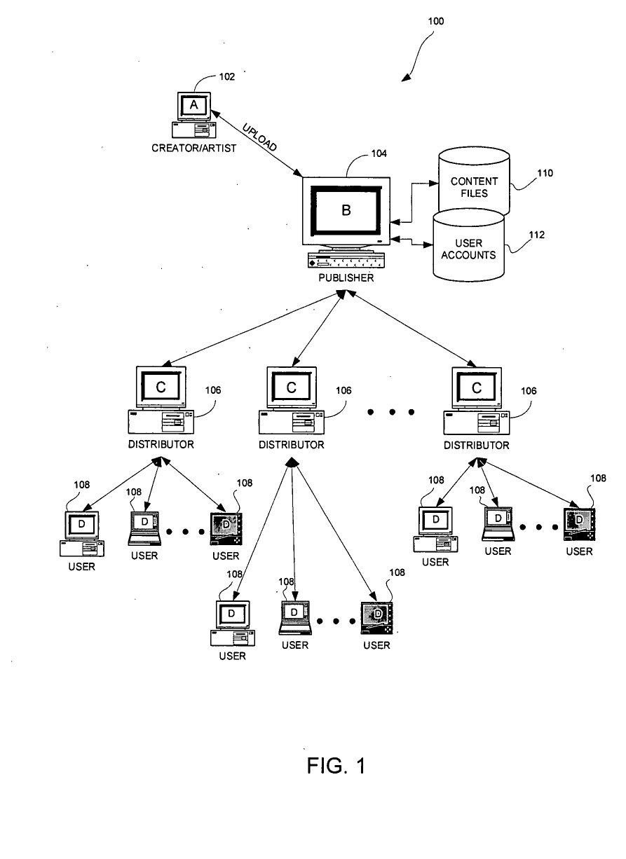

In utilizing the methods and systems of the present disclosure described herein, a user will be able to accomplish the various applications of the disclosure which are described below in relation to FIG. 1, which illustrates an overall flow diagram of the method and system 100 of the present disclosure.

A digital content creator 102 (hereinafter A) wishes to distribute his content on the global computer network (GCN), e.g., the Internet, and to be paid for this content on a per use basis. It is to be appreciated that for the purpose of the present disclosure digital content or a digital content file may include an audio file, a video file, a text file, a multimedia file, a software application such as games, productivity programs, etc., and various other known digital file types. Creator A uploads the content to a server or storage site 104 for the content on the GCN (hereinafter called B). B, also known as the publisher of the digital content, markets the content on the Internet to let interested parties know of the content. B also acts as the payment agent for the content. Additionally, in another embodiment of this disclosure, creator A may also cause the content to be stored or to have a hyperlink to the content stored on another distributors or multiple distributors websites 106 (hereinafter called C). Examples of these distributors include digital content resellers such as iTunes of Cupertino Calif., and Podcast.com also of California. Once the content is placed with distributors 106, e.g., C, by B, the end users 108 will be able to download the content from the distributors website 106. The users (hereinafter called user D) will have an incentive to purchase the content published by B as follows.

For the first predetermined number of D users to purchase the content from B, B will pay those users a percentage of the revenue collected by B. This money, credits or funds will be placed into an electronic account that B will set up for the D users. Further, for the next predetermined number of D users to purchase the content from B, B will pay those users including the original predetermined users, a percentage of the revenue collected by B. Further, for the next or third predetermined number of D users to purchase the content from B, B will pay those users including the original users, a percentage of the revenue collected by B. This system of incentivation will continue for all D users of the content. B will also pay the content provider (A) a percentage of the revenue, and also will pay the content distributor C (if there is a distributor) a percentage of revenue. The balance of the revenue will be maintained by B.

In a preferred embodiment, B or the publisher 104 of the digital content will be an application service provider (ASP) residing on a server and all transactions to be described will occur electronically, via a hardwired or wireless connection, over a network of computers, e.g., the Internet. Each of the users, e.g., A 102, C106, D 108, will be coupled to the publisher 104 via a client application, e.g., an Internet browser, and will access the publisher 104 via a web interface, e.g., an HTML constructed web page.

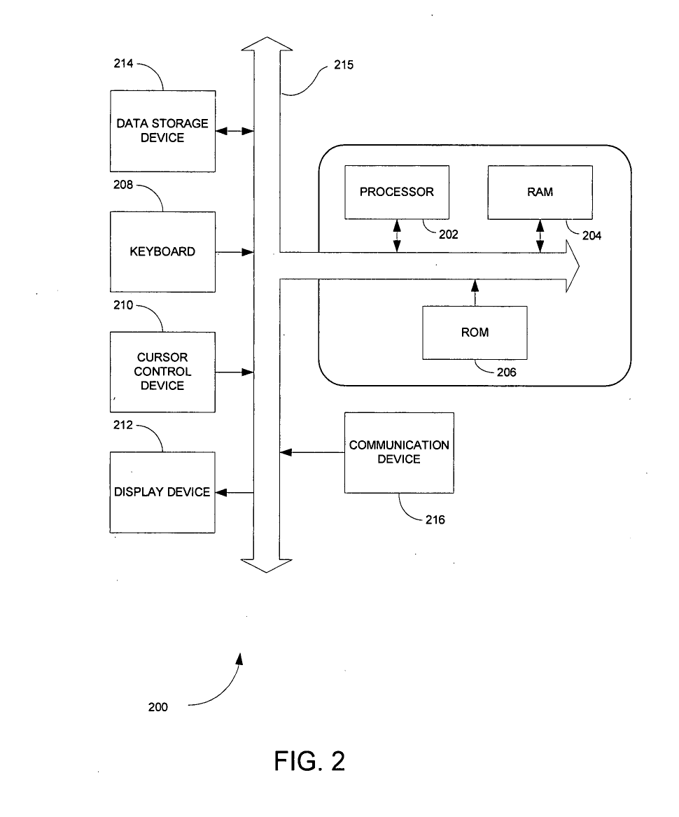

It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine comprising any suitable architecture such as server 104. Referring to FIG. 2, preferably, the machine 200 is implemented on a computer platform having hardware such as one or more central processing units (CPU) 202, a random access memory (RAM) 204, a read only memory (ROM) 206 and input/output (I/O) interface(s) such as a keyboard 208, cursor control device 210 (e.g., a mouse or joystick) and display device 212. A system bus 215 couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof which is executed via the operating system.

In addition, various other peripheral devices may be connected to the computer platform by various interfaces and bus structures, such as a parallel port, firewire (IEEE 1394) serial port or universal serial bus (USB). One such peripheral device may include a communications device 216, e.g., a modem, network interface card (NIC), satellite relay, wireless connection, etc., for enabling communications from the server of the publisher 104 to various clients, e.g., content provider 102, distributor(s) 106 and end user(s) 108, for accessing the digital content files. Other peripheral devices may include additional storage devices 214 and a printer.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The server 104 may operate in a networked environment using logical connections to one or more remote computers. The remote computer(s) may be a personal computer, a server, a router, a network PC, a peer device or other common network node, and typically includes many or all of the elements described above relative to the server 104. It is to be appreciated that the network may be a local area network (LAN), wide area network (WAN), the Internet or any known network that couples a plurality of computers to enable various modes of communication via network messages. Furthermore, the server 104 will communicate using the various known protocols such as Transmission Control Protocol/Internet Protocol (TCP/IP), File Transfer Protocol (FTP), Hypertext Transfer Protocol (HTTP), etc. and secure protocols such as Internet Protocol Security Protocol (IPSec), Point-to-Point Tunneling Protocol (PPTP), Secure Sockets Layer (SSL) Protocol, etc. The server 104 will further include a storage medium for storing a repository of digital media content 110 and a database of user accounts 112.

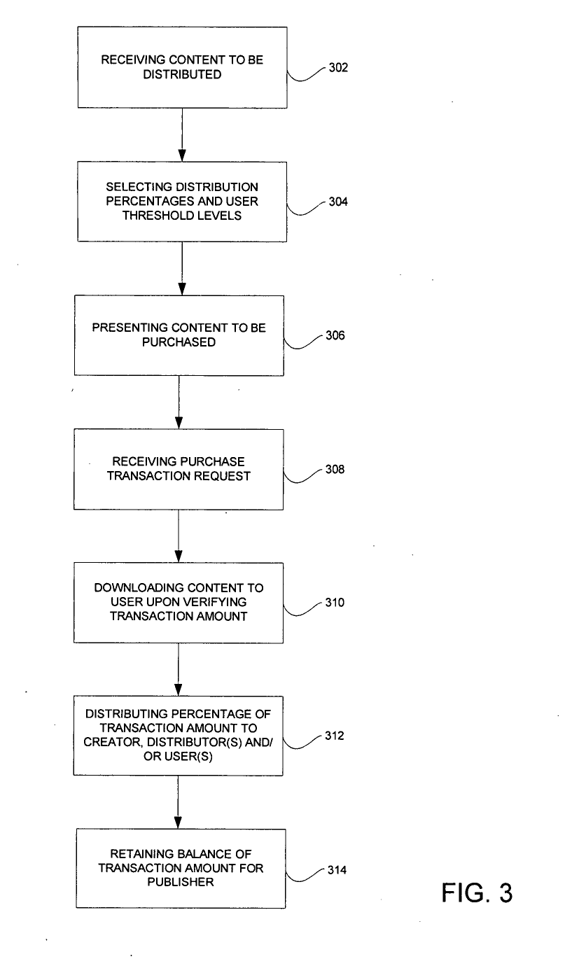

With reference to FIGS. 1 and 3, the method and system of the present disclosure will now be described.

Initially, a digital file is uploaded by the content provider (A) 102 from a computer terminal to remote server 104 on the GCN (step 302). In this case the file is stored in memory storage 110 on the remote server 104. Alternatively in another embodiment of the present disclosure, the file's address (e.g., a hyperlink to the file) is uploaded from computer terminal 102 to the remote server 104 on the GCN and this file address is stored in memory 110 on the remote server. In this embodiment, the actual digital file would remain on the local server stored in memory storage (e.g., hard drive, flash memory, CD or DVD, etc), or may remain located on another remote server (the distributor C) for access by the users D.

Next, in step 304, the content provider (A) will select with the remote server operator as to the percentages of revenue to share with the user's of the digital content (D), the distributor of the digital content (C), and the initial storage site/agent for the content or the address of the content (B). In one embodiment, the selecting of the distribution percentages will be negotiated electronically between the content provider and the remote server. For example, the content provider will access a web site of the remote server 104 and select the distribution percentages and the publisher/provider of the remote server will approve of the percentages if acceptable or will transmit back to the content provider new percentages. These new percentages may be accepted or rejected by the content provider. If rejected, the content provider will suggest a different set of percentages and will go back and forth with the publisher/provider of the remote server until a set of percentages is mutually agreed upon. The parties would also select as to the number of users that will receive different percentages of revenue, e.g., user threshold levels (UTL). By example, the first 10,000 users will receive 50% of the revenue, and the next 30,000 users including the first 10,000 users to receive 40% of the revenue. As these percentages are adjusted, the revenue given to the file agent (B) and the distributors (C) will also vary so that at the conclusion all parties share a total of 100% of the revenue. Furthermore, when a predetermined threshold of purchases has occurred, e.g., if the content is extremely successful, the content provider may re-negotiate the distribution percentages with the publisher/provider of the remote server.

After the distribution percentages and user threshold levels are set, the digital file is presented to be purchased by a user D. In one embodiment, the digital file will be directly available from the publisher (B) via a website residing on server 104. In another embodiment, the file will be accessible from a distributor (C), e.g., iTunes, Audible.com, etc. Although user D will access a website of the distributor (C), the digital file may reside on memory storage 110 of server 104. Furthermore, server 104 will also store a plurality of user accounts 112 either on the same memory storage device as the content file or on a separate memory storage device. User accounts 112 will be maintained for all users, e.g., A, B, C, D, to keep track of the incentive payment to each user.

In step 308, the server 104 will receive a purchase transaction request from user D and will download the digital file upon verifying the transaction amount, in step 310. The digital file is accessed on the GCN by user (D) and is downloaded through the GCN by the user. In one embodiment of the disclosure, the file is encrypted. Encryption algorithms can include DES, AES, Blowfish, Cast, or any other type of file encryption algorithm currently known or that may be known in the future. The user would then contact the file agent (B) through the GCN and would pay the file agent with a standard e-commerce transaction (including but not limited to payment by credit card, bank debit, payment agent, wire transfer, etc), and the file agent (B) would give the code to the end user (D) and the file would be unencrypted and in usable form. Alternatively, in another embodiment of this disclosure, the user would contact the file agent (B) through the GCN and would pay the file agent with a standard e-commerce transaction (including but not limited to payment by credit card, bank debit, payment agent, wire transfer, etc), and the file agent (B) would give the address of the digital file (including providing a hyperlink to the file) to the user (D) and the file would be able to be accessed and downloaded by the user (D). In this embodiment, the file or file address may be resident at another remote location and be available for download with the file's distributor (C).

Once the file agent/publisher (B) has received payment for the digital file, the agent would then distribute the transaction amount in the percentages agreed to by the agent (B) and the content provider (A), to the content provider (A), the file distributor (C), and the file users (D) (step 312). The file agent/publisher (B) will retain the balance of the transaction amount after distribution (step 314). This distribution of payments may be in any form currently known or that will be known in the future, including payment by checks, credits to bank accounts, wire transfer, issuance of cash redemption cards, payment by a payment agent, or issuance of credits to be used for additional services provided by file agent/publisher (B). In one embodiment, the file agent/publisher will track the distributed funds for each user in user accounts 112 and only transfer credit to the user upon the user's account exceeding a predetermined amount. The credit in the user account may be used for purchasing other digital content files maintained by the file agent (B).

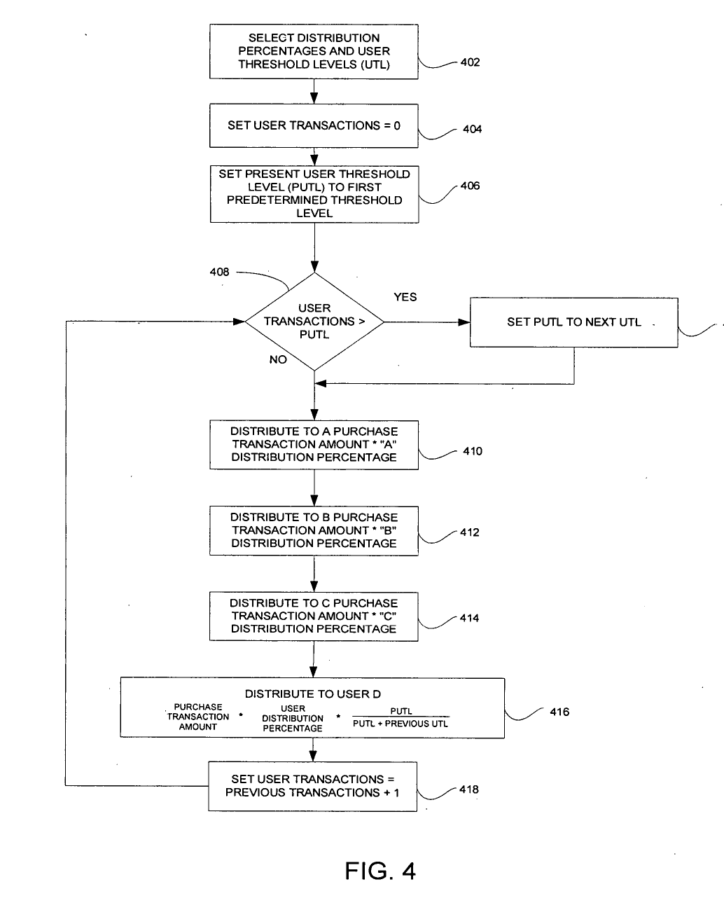

Referring to FIG. 4, an illustrative example of the method of the present disclosure is provided. Initially, in step 402, a content provider (A) uploads a file to B and A and B agree to distribute the file with the following payments—20% of the gross revenue to A, 10% to B, and for the first 1000 users (D) 50% of the revenue. Additionally, the distributor (C) will receive 20% of the revenue. Furthermore, the user threshold levels (UTLs) will be predetermined to be 1000; 10,000; 100,000; and 1,000,000.

In step 404, the number of user transactions associated with the uploaded file will be set to zero and the present user threshold level (PUTL) will be set to the first predetermined user threshold level (UTL), for this example 1000 users, in step 406.

In this example, the digital file will sell for $15.00. Thus, in the ‘first round’, the server 104 will determine if the number of user transactions is greater than the first user threshold level (step 408). Since initially, the user transactions is set to zero, B will distribute the purchase transaction amount according to the agreed upon percentages for the first UTL; in step 410, distribute to A an amount equal to the purchase transaction amount times the “A” distribution percentage (20%) or $3.00; in step 412, distribute to B an amount equal to the purchase transaction amount times the “B” distribution percentage (10%) or $1.50; and in step 414, distribute to C an amount equal to the purchase transaction amount times the “C” distribution percentage (20%) or $3.00. The distribution to each of the D users will depend on the user threshold level and will be determined by the following formula:

$$( \begin{matrix}purchase transaction \\ amount\end{matrix} ) * ( \begin{matrix}user distribution \\ percentage\end{matrix} ) * ( \frac{present user threshold level ( PUTL )}{PUTL + previous user threshold level} ) \qquad ( 1 )$$

In this ‘first round’, the purchase transaction amount is $15.00, the user distribution percentage is 50%, the present user threshold level (PUTL) is 1000 and previous user threshold levels is zero; therefore, the distribution to each user D is $7.50, in step 416. Assuming at least 1000 D users make a purchase in this ‘first round’, B will distribute $3000 to A, $1500 to B (themselves), $3000 to C, and the D users would receive $7,500. Depending on the agreement between B and D as defined when user D creates a user account, the payment of $7.50 for each D user may be accrued in an account for the user allowing the user to use this credit against other digital file purchases, or D would receive a payment for this amount through bank transfer, credit card transfer, electronic transfer, or a mailed check (or any other means currently available or hereinafter available for payment transfers.)

After the funds are distributed, the number of user transactions is incremented by one, in step 418, and the method returns to step 408 to determined if the number of user transactions has exceeded the present user threshold level (PUTL). When the number of user transactions exceeds 1000, the method will go to step 420 where the present user threshold level will be set to the next user threshold level (UTL), e.g., 10,000, and the ‘next round’ of distribution will begin. In the ‘next round’, A-D would receive the same payment percentages and the round would apply to the next 10,000 purchasers of the digital content (D) and would also include the original 1000 previous purchasers (D). Thus in this round, A would receive 30,000, B to receive $15000, C to receive $30000, and the 11000 users (i.e., 10,000 of the present UTL plus 1,000 of the previous UTL) would receive $75000 or $6.82 each as determined by the following using formula (1) above:

$$( \$15 .00 ) * 50 \% * ( \frac{10 \text{,} 000}{10 \text{,} 000 + 1 \text{,} 000} ) = \$6 .82$$

In the ‘next round’, when the number of user transactions exceeds 10,000 in step 408, the present user transaction threshold level will be set to 100,000. A-D will receive the same payment percentages and the round would apply to the next 100000 purchasers of the digital content and would also include the previous 11,000 purchasers. Thus in this round, A would receive $300,000, B to receive $150,000, C to receive $300,000, and the 111,000 users would receive $750,000 or $6.76 each as determined by the following using formula (1) above:

$$( \$15 .00 ) * 50 \% * ( \frac{100 \text{,} 000}{100 \text{,} 000 + 11 \text{,} 000} ) = \$6 .76$$

In this example's final round, A-D would receive the same payment percentages and the round would apply to the last one million purchasers of the digital content and would also include the previous 111,000 purchasers. Thus, in this round, A would receive 3 million dollars, B to receive 1.5 million dollars, C to receive 3 million dollars, and the 1,111,000 purchasers would receive $6.75 each as determined by the following using formula (1) above:

$$( \$15 .00 ) * 50 \% * ( \frac{1 \text{,} 000 \text{,} 000}{1 \text{,} 000 \text{,} 000 + 111 \text{,} 000} ) = \$6 .75$$

The D users will have an incentive to purchase these digital content files as early as possible, because the sooner that they purchase, and the more people they tell about the files, the more money that they make. In the example described above, the first 1000 purchasers of the $15.00 digital content files, would have received $27.83 for a digital file that they paid only $15.00 to purchase.

The system and method of incentivation described herein can also be adjusted so that the early users (i.e., early adopters) of the digital files, would receive even a higher level of compensation so that for instance if a total disbursement was made of several million dollars, the first users of these files could receive a substantial portion of the total revenue.

In another embodiment of the present disclosure, a system and method for providing a payment incentive to users to access free digital content over a network and placing the content on an alternate Internet site, e.g., a promotion web site, is provided. A user will sign up/register to an Internet promotion service on a remote server that promotes digital content. The user will register before they attempt to locate content of interest or may register at the time the user finds the content. At the promotion web site, the user will enter payment account information, as well as other identity information, and optionally, the user is assigned and enabled to set up an individual webpage on the Internet content promotion site. As will be described below, the individual webpage will allow the user to list/post the content of interest that the user desired to promote. In one embodiment, the user will be been given a computer software program, e.g., a client application, to download which is provided from the promotion site's remote server, and is downloaded by the user to his local computer, e.g., a client computer, and then placed in digital memory storage for code execution by the local processor. This software program will enable the user to list/post the content on the user's individual webpage. In an alternative embodiment, the user will download a toolbar that will run in conjunction with the user's web browser program, e.g., Microsoft Internet Explorer. In this embodiment, as the user is searching for content, the user may designate content to be listed/posted by simply selecting a button on the toolbar while the content is being played on or within the user's web browser program.

Once the user's account and individual web page is established, the user locates digital content on a website that he or she is interested in using and promoting (step 502). Examples of digital content web sites include but are not limited to Revver, You Tube, My Space, etc. At this point, the user will view the content which for example may be a video. It is to be appreciated that the content may take any known form or to be developed form and may include but is not limited to an audio file, e.g., a music selection; a video file; a text file, e.g., an e-book; a multimedia file; a software application; a gaming application, etc.

Once the user locates content of interest to him at any remote Internet site such as the sites previously mentioned, the user activates the software program that has been provided. Such activation may be by keyboard or mouse input or optionally by voice recognition software. Alternatively, activation may be initiated by selecting a button on a toolbar associated with a web browsing program used to locate content. Once the software program is active, the software program, e.g., the client application, will analyze the source code of the digital content that the user has selected to determine a location and type of the content file (step 504). The software program will then prompt the user if the user wishes to promote this content (step 506). If the user does not desire to promote the content, the user may continue searching for additional content.

If the user elects to promote the content, then the software program will charge the user a predetermined fee for this promotion (step 508). In one example, the fee would be 0.25 cents. This fee will be deducted from the user's payment account in a standard ecommerce transaction and the user would be informed of this purchase/payment deduction. The user will then be asked if he wishes the selected content to be listed or presented on his/her web site page on the aforementioned Internet promotion site. If the user elects to have the content listed, the software program will utilize the analyzed source code to list the content with a URL reference link on a portion of the web site associated to the user promoting the content (step 510). By example, content for a specific video on You Tube would be referenced by the link http://www.youtube.com/watch?v=V-a3oofQFpY. When this link is accessed, a user will be directed to a web page containing the content file and the video would appear. In another embodiment of the present disclosure, the software program may utilize the content source code to embed the digital content on the user's selected web page. This process of embedding means that the actual digital player engine is ready to be accessed by any user when they go to the user's associated web page. Initializing the player engine will then play the selected digital content.

Once the user has embedded, linked or posted the content to an associated web page located on the Internet promotion site, the user can now notify subsequent users/promoters by e-mail, instant messaging, voice communications (e.g., VoIP) or any other form of communication to let other Internet users know that he/she is promoting the selected digital content (step 512). As subsequent users view or play the content file, the subsequent users, e.g., other client applications, will have the option of further promoting the digital content file. If a subsequent user decides to promote the content file, the subsequent user will be pay a promotion fee or be charge the promotion fee as described above (step 514). When a predetermined threshold of subsequent users promote the content file, a percentage of the promotion fees collected will be distributed to the promoters (step 516). It is to be appreciated that the collected promotion fees may be distributed to all of the subsequent users/promoters or to a smaller subset of users/promoters determined by a second threshold of users/promoters.

The user who first located the content will be motivated to promote the content because the system and method of payment incentives of the present disclosure will reward the early promoters, for example, the first x number of promoters of the content will receive y percentage of the total promotional revenue after z users have promoted the content. By example in the above case, the promotion for the video, i.e., the selected content, costs the user 0.25 cents. In this case, the file agent of the Internet company running the promotion web site would retain twenty percent of the entire promotion revenue collected, and distribute eighty percent of the revenue to the first 100 content promoters. In this example, if 2000 users promoted the content and paid 0.25 cents per promotion, then each of the first 100 users would receive four dollars each. If 2000 total users/promoters pay to also promote the content then a total of $500.00 would have been collected. Out of this $500.00, the file agent of the promotion web site takes (in this example) 20% or $100.00. The balance of the $400 will be distributed to the earliest promoters. In this case example, the: earliest promoters are designated to be the first 100 users/promoters of the content. In this case example they would each receive $4.00 for their work in promoting.

In another example of promotion of a music track, if each of the users paid 0.20 cents to promote the track, and 4000 promotions occurred, and the first 300 persons were rewarded during the promotion, then these 300 users would each receive $2.13 each. For example, 4000 promotions at 0.20 cents each would result in $800.00 collected. The promotion web site would retain twenty percent of the collected promotion fees or $160.00. The first 300 promoters will then share the balance, i.e., $640.00, or $2.13 per user/promoter.

The Internet promotion site will want to let potential promoters know the track record of the first promoter who located the content and placed the content on his/her webpage at the promotion site. Therefore, the promotion website will tell the potential promoters how much money in the past the first promoter has made at the site, e.g., the promoter's success rate. The formula for this advisory will be as follows: how much cumulative money the first promoter has made to date divided by the cumulative amount of money the promoter has spent in placing this and other content on the promotion web site. By example, if a promoter has made $1000 to date on the promotion web site, and spent $50.00 in promoting content then his quotient would be 20. In another example, if the first promoter made $70,000 to date on the promotion web site and spent only $10.00 in promoting any content then his quotient would be 7000. The potential subsequent promoters will realize as they look at content on the individual web pages at the promotion site, that the larger the quotient then the better that the promoter has done in effectively promoting content.

Another indicator that will be posted on the web page for the promoter would be the cumulative amount of money that the promoter has made on the site. Potential promoters will be able to use this information as a guide to the promoter's ability to promote content.

In a further embodiment, the software program will verify if the content is copyright protected before posting/presenting the content on the promotion website. For example, upon selecting a content file to be promoted, an e-mail will be sent automatically to an originator of the content for approval or a royalty free license. Alternately, the user/promoter could use various known Digital Rights Management (DRM) software to verify that the content is the publishers and available for use, or alternatively, notify the publisher of the content for a license.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method for distributing digital content files over a network, the method comprising the steps:
providing a web site for promoting content hosted by at least one server in communication with the network;
receiving an indication of at least one digital content file by the web site from a first user;
charging the first user a predetermined payment amount to promote the at least one digital content file;
presenting the at least one digital file for promotion on a portion of the web site associated with the first user, wherein subsequent at least one second users pay the predetermined amount for promoting the at least one digital content; and
distributing to the first user a first distribution percentage of a total of the predetermined amounts collected.

2. The method as in claim 1, further comprising distributing a second distribution percentage of the total collected to a file agent of the at least one server hosting the web site.

3. The method as in claim 2, further comprising:
determining a first threshold of subsequent at least second users; and
distributing the first distribution percentage of the total collected to a number of subsequent at least second users equal to the first threshold.

4. The method as in claim 1, wherein the at least one digital content file is an audio file, a video file, a multimedia file, a text file or a software application.

5. The method as in claim 1, further comprising notifying the at least one second user of the presented at least one digital file.

6. The method as in claim 5, wherein the notifying the at least one second user is performed by e-mailing or instant messaging.

7. The method as in claim 1, wherein the presenting the at least one digital file includes posting a link on the portion of the web site associated to the first user indicative of a location of the at least one digital content file.

8. The method as in claim 1, wherein the presenting the at least one digital file includes embedding the at least one digital content file on the portion of the web site associated to the first user.

9. The method as in claim 1, wherein the charging the first user further comprises:
prestoring account information of the first user; and
automatically deducting the predetermined payment amount from the account information of the first user upon selection of the at least one digital content file by the first user.

10. The method as in claim 1, further comprising:
receiving an indication of an identity of the first user; and
deducting the predetermined amount from an account associated with the first user.

11. The method as in claim 1, further comprising presenting on the web site a promotion success rate for the first user.

12. The method as in claim 11, wherein the promotion success rate equals a total amount distributed to the first user divided by a total charged to the first user for promotion the at least one digital file.

13. A server for distributing digital content files over a network comprising:
a processor configured for providing a web site for promoting content;
a communication device configured for coupling the server to the network and receiving an indication of at least one digital content file by the web site from a first user; and
the processor further configured for charging the first user a predetermined payment amount to promote the at least one digital content file, presenting the at least one digital file for promotion on a portion of the web site associated with the first user, wherein subsequent at least one second users pay the predetermined amount for promoting the at least one digital content; and distributing to the first user a first distribution percentage of a total of the predetermined amounts collected.

14. The server as in claim 13, wherein the processor is further configured for distributing a second distribution percentage of the total collected to a file agent of the at least one server hosting the web site.

15. The server as in claim 14, wherein the processor is further configured for determining a first threshold of subsequent at least second users; and distributing the first distribution percentage of the total collected to a number of subsequent at least second users equal to the first threshold.

16. The server as in claim 13, wherein the at least one digital content file is an audio file, a video file, a multimedia file, a text file or a software application.

17. The server as in claim 13, wherein the processor is further configured for notifying the at least one second user of the presented at least one digital file.

18. The server as in claim 17, wherein the notifying the at least one second user is performed by e-mailing or instant messaging.

19. The server as in claim 13, wherein the processor is configured for posting a link on the portion of the web site associated to the first user indicative of a location of the at least one digital content file.

20. The server as in claim 13, wherein the processor is configured for embedding the at least one digital content file on the portion of the web site associated to the first user.

21. The server as in claim 13, further comprising a memory configured for prestoring account information of the first user and the processor further configured for automatically deducting the predetermined payment amount from the account information of the first user upon selection of the at least one digital content file by the first user.

22. The server as in claim 13, wherein the communication device is further configured for receiving an indication of an identity of the first user and the processor is further configured for deducting the predetermined amount from an account associated with the first user.

23. The server as in claim 13, wherein the processor is further configured for presenting on the web site a promotion success rate for the first user.

24. The server as in claim 23, wherein the promotion success rate equals a total amount distributed to the first user divided by a total charged to the first user for promotion the at least one digital file.

25. A program storage device readable by a machine, tangibly embodying a program of instructions executable by the machine to perform method steps for distributing digital content files over a network, the method steps comprising:
providing a web site for promoting content hosted by at least one server in communication with the network;
receiving an indication of at least one digital content file by the web site from a first user;
charging the first user a predetermined payment amount to promote the at least one digital content file;
presenting the at least one digital file for promotion on a portion of the web site associated with the first user, wherein subsequent at least one second users pay the predetermined amount for promoting the at least one digital content; and
distributing to the first user a first distribution percentage of a total of the predetermined amounts collected.

26. A method for distributing digital content files over a network, the method comprising the steps:
providing at least one first client application in communication with the network;
selecting at least one digital content file on the network with the at least one client application for promotion;
presenting the at least one digital content file for promotion on a portion of a web site for promoting content residing on at least one server, the portion of the web site being associated with the at least one first client application, wherein subsequent at least one second client application pays a predetermined amount for promoting the at least one digital content; and
receiving by the at least one first client application a first distribution percentage of a total of the predetermined payments amounts collected.

27. The method as in claim 26, further comprising charging the at least one first client application a predetermined payment amount to promote the at least one digital content file.

28. The method as in claim 26, wherein the at least one digital content file is an audio file, a video file, a multimedia file, a text file or a software application.

29. The method as in claim 26, further comprising notifying the at least one second client application of the presented at least one digital content file by the at least one first client application.

30. The method as in claim 29, wherein the notifying the at least one second client application is performed by e-mailing or instant messaging.

31. The method as in claim 26, further comprising analyzing the at least one digital content file to determine a location of the at least one digital content file on the network, wherein the presenting the at least one digital file includes posting a link on the portion of the web site associated to the first user indicative of the location of the at least one digital content file.

32. The method as in claim 26, further comprising analyzing the at least one digital content file to determine a location of the at least one digital content file on the network, wherein the presenting the at least one digital file includes embedding the at least one digital content file on the portion of the web site associated to the at least one first client application.

33. An apparatus for distributing digital content files over a network comprising:
at least one first client application in communication with the network;
means for selecting at least one digital content file on the network with the at least one client application for promotion;
means for presenting the at least one digital content file for promotion on a portion of a web site for promoting content residing on at least one server, the portion of the web site being associated with the at least one first client application, wherein subsequent at least one second client application pays a predetermined amount for promoting the at least one digital content; and
means for receiving by the at least one first client application a first distribution percentage of a total of the predetermined payments amounts collected.
